(19) United States
(12) Patent Application Publication
(10) Pub. No.: US 2003/0014340 A1
(43) Pub. Date: Jan. 16, 2003

(54) System and method for funding evaluation

(75) Inventors: Damir Perge, Saratoga, CA (US); Cheryl Hammer, Saratoga, CA (US); Raveesh K. Kumra, Monte Sereno, CA (US); Lori Lynne Colivas, Pittsburg, CA (US); William J. Kolegraff, Jamul, CA (US)

Correspondence Address: William J. Kolegraff, 3119 Turnberry Way, Jamul, CA, 91935, US

(73) Assignee: Futuredex, Inc.

(21) Appl. No.: 09/946,762

(22) Filed: Sep. 5, 2001

Related U.S. Application Data
(63) Continuation of application No. 09/904,645, filed on Jul. 13, 2001.

(51) Int. Cl. G06F 17/60

(52) U.S. Cl. 705/35

(57) ABSTRACT

The funding method and system operates on an information network and has a database of members. A funding event manager solicits member companies or funders to participate in a funding competition. Participating companies provide information, which is systematically filtered to select companies meeting event criteria. Experts, which are also selected from the member database, review the selected companies to choose finalist companies. Information regarding the finalist companies is presented to members in the member database, and responding members evaluate finalist companies. The evaluations are used in selecting one or more of the finalist companies to receive funding.

This application is related to U.S. patent application Ser. No. 09/904,645, filed Jul. 13, 2001, and entitled “System and Method for Matching Business Partners”, which is incorporated herein by reference as if set forth in its entirety. The field of the present invention is on-line systems. More particularly, the present invention relates to a funding event operating on an Internet event web site.

### BACKGROUND

An important aspect of a country's economy is the growth and expansion of start-up companies. For example, much of the growth in the United States' economy in the 1990s was due to the technological advances and hiring by new and expanding companies. To facilitate proof of concept, expansion and growth, companies rely on a ready supply of working capital. Depending on the financial stage of a company, companies may seek funding from different sources. For example, a new company may entirely self-fund for its initial formation. However, most self-funding companies quickly deplete available funding sources and require injection of capital from additional sources.

It is therefore common for a start-up company to seek funding from a class of funders called angel investors. Such angel investors, in return for an ownership position in the start-up company, agree to fund the start-up on a limited basis. As the company grows and expands, the financial resources available to the angel investors may again become inadequate. The growing company may now look for funding from venture capitalists. Venture capitalists, which tend to be sophisticated investors, are generally capable of investing much larger sums of money into the company. Depending upon the needs of the company, the company may later seek funding from investment bankers, or open the company to general investment through an initial public offering (IPO). For a growing company, seeking and acquiring capital is a major business activity requiring substantial management time and company resource.

The process by which a company seeks funding, especially at the earlier stages, is generally a highly informal process. For example, management in the company may have personal contacts with investors or other funders. Based on these contacts, and subsequent introductions to other investors, the company seeks funding by “selling” its strength and potential to individual investors. Such a process is not only inefficient, but is time consuming and often unsuccessful. To increase funding opportunities, companies often try to disseminate company information widely to attract the attention of a greater number of investors. In such a manner, these companies may advertise their funding requirement in publications targeted to investors, may publish information on web sites visited by investors, or may seek to make presentations at occasional informal investor meetings.

However, distributing information in such a broad, haphazard way may result in the overly widespread dissemination of private company information. Competitors or others may then use such information to the detriment of the company seeking funding. Accordingly, the company may restrict the amount or completeness of the information publicized to potential investors. But because the information may have been so restricted to maintain company security, investors may not receive enough information to cause them to formally contact the company to seek additional information. In general, known methods of funding companies suffer from fragmented, incomplete information on companies seeking funding. Further, the information being disseminated about the company seeking funding may not have been validated by any trustworthy source. In such a manner, it is unlikely that an investor will be able to trust the information without substantial effort and due diligence.

Known funding methods also are undesirable for funders. For example, the process of collecting information on a company seeking funding is inefficient and resource consuming. Further, it is often necessary to involve specialists, for example in technology or finance, to more thoroughly evaluate a particular company. Such collaborations tend to be informal, with the resulting analysis providing limited value. For more thorough collaboration, more complete and accurate value may be accessed, but at the cost of time and money.

Known funding systems and methods suffer from incomplete and fragmented information and inefficient collaboration. Such lack of information and inability to timely collaborate result in a system requiring companies seeking funding to invest substantial time and effort in arranging for capital instead of managing and building their company. In a similar manner, entities seeking investment opportunities must spend considerable time collecting and analyzing information prior to making a funding decision. Accordingly, there is a need for a funding system and method that enables the efficient collection of information regarding companies seeking funding, the effective and timely collaboration of specialists, and improves the trustworthiness and reliability of knowledge. Under such a system companies seeking funding could more effectively present their company position, and investors seeking opportunities could more fully and timely evaluate the opportunities.

### SUMMARY

The system and method for funding evaluation facilitates the efficient and effective collection, presentation, and analysis of information regarding companies seeking funding. Briefly, the funding method operates on an information network and has a database of members. A funding event manager solicits member companies or funders to participate in a funding competition. Participating companies provide information, which is systematically filtered to select companies meeting event criteria. Experts, which are also selected from the member database, review the selected companies to choose finalist companies. Information regarding the finalist companies is presented to members in the member database, and responding members evaluate finalist companies. The evaluations are used in selecting one or more of the finalist companies to receive funding.

In one embodiment of the funding method, participating companies enter company information and may identify components of the information as sharable or private information. The experts may use both the private and the sharable information to perform a comprehensive review of the company, while the private information is not generally available to other members. Accordingly, members evaluating finalist companies may access information each company has identified as sharable, and may have access to the expert analysis, but the security of private company information is maintained.

In another embodiment of the funding method, the trustworthiness of a particular member's opinion, such as an expert, is rated. The rating is used to weight the analysis performed by the particular member. In such a manner, the opinion of a highly trusted member is accorded more influence in the selection process than a member with a lower trust rating.

Advantageously, the new funding system and method enables companies to more effectively compete for funding, while maintaining the security of private information. More specifically, funding information is collected and presented in a more complete and trustworthy manner than with known funding methods. Further, the funding system and method enables a comprehensive and timely collaboration between funders, companies, and experts. Based on the trustworthiness of information and the high level of collaboration, funding decisions can be made with substantially less risk than with known systems.

### BRIEF DESCRIPTION OF THE DRAWINGS

FIG. 1 is a block diagram of a method for funding a company in accordance with the present invention;

FIG. 2 is a block diagram adding detail to the method for funding shown in FIG. 1;

FIG. 3 is a block diagram of another method for funding a company in accordance with the present invention;

FIG. 4 is a block diagram showing interactions between entities during a funding event in accordance with the present invention;

FIG. 5 is a block diagram of a system for funding a company in accordance with the present invention; and

FIG. 6 is a block diagram showing data flow in a method for funding a company in accordance with the present invention.

### DETAILED DESCRIPTION

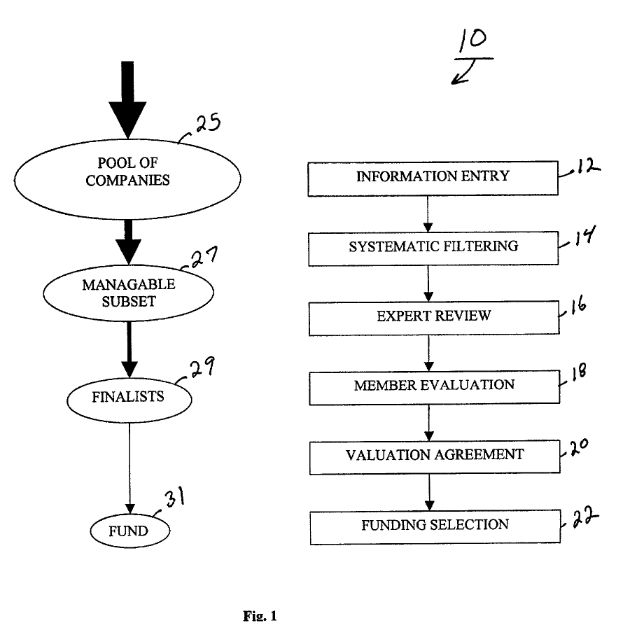

Referring now to FIG. 1 a method of funding 10 in accordance with the present invention is shown. Method 10 is advantageously implemented to facilitate the efficient communication of information between companies seeking funding and potential investors. In its preferred embodiment, method 10 operates on a computerized network, such as the Internet. More particularly, the method 10 is implemented on an Internet server, providing access to a secure event website. The computer network facilitates efficient communications independent of geographic location. The event website is used to manage the collection of information, enable effective collaboration efforts, and facilitate funding decisions.

Funding method 10 may be structured in the form of a funding competition. In such a manner, an event manager arranges for a fund of money, and uses method 10 to attract, evaluate, and select company-funding opportunities. The funding competition provides the successful company or companies with a new funding source, and provides other competing companies with exposure and valuable feedback regarding their companies.

Referring again to FIG. 1, each company participating in the funding event accesses the event website to provide company information. The method 10 receives the information from each company seeking funding as shown in block 12. Due to the desirability and easy accessibility of funding method 10, it is expected that many companies will enter their information. Accordingly, a pool of companies 25 may be competing for limited funds. It is also expected that each participating company or funder will comply with all regulations governing such a funding event.

In practical applications, funding method 10 is likely to be managed by the event manager. The event manager defines the selection criteria for the funding event, is likely to manage the fund, and solicits companies and specialists to participate in the funding event. Further, the event manager typically manages the event website. In its most preferred embodiment, the funding event may be structured as a funding competition.

The pool of companies 25 may likely contain more companies than can be comprehensively reviewed. Therefore, the method 10 applies systematic filtering as shown in block 14 to reduce the number of companies in the pool of companies 25 to a manageable subset 27. The systematic filtering 14 may be for example, a simple gating function that uses information provided by each company to eliminate companies not meeting desired requirements. Such a gating function may be operated on just a few data points, making the gating function an efficient method to quickly reduce the number of companies in the competition.

A more sophisticated systematic filtering may perform additional algorithmic analysis on each company's information to establish a closeness of fit to desired company characteristics. Typically, the event manager will be responsible for selecting the type and completeness of the systematic filtering. It will be appreciated that other methods of systematic filtering may be used consistent with this disclosure.

Experts review the manageable subset of companies 27 as shown in block 16. Expert review 16 may take the form of one or more evaluations, with subsequent evaluations providing more comprehensive review. For example, experts may initially analyze the manageable subset of companies 27 using fairly automated techniques such as spreadsheet manipulation of the companies' information. It will be appreciated that the analysis may be assisted using other programs or algorithms. As companies are removed from the manageable subset 27, the experts may resort to more manual processes such as personal interviews and business plan reviews in performing their comprehensive review.

In a preferred embodiment of funding method 10, the method maintains a member database associated with the event website. Members, which may include companies seeking funding, specialists, and entities seeking funding opportunities, may be registered into the database well in advance of the funding event. For example, co-pending U.S. patent application Ser. No. 09/904,645, entitled “System and Method for Matching Business Partners”, describes a system and method for populating a member database with member information. Under funding method 10, it is likely that each of the companies in the pool of companies 25 has registered as a member in the member database, and that each of the experts selected for review in block 16 has also registered as a member in the member database. Such pre-registration increases the reliability of information and enables a historical perspective to assess trustworthiness of members.

The experts in blocks 16 select a small number of companies to be finalists as shown in block 29. Information regarding these finalists is presented to the members in the member database as shown in block 18. In the preferred embodiment, finalist information is presented to members on the event website. For example, each day a different finalist may be presented on the event website. After a series of days, all finalists will have had an opportunity to be evaluated by members.

Members visiting the event website are encouraged to review, analyze, and rate each of the finalists as to each finalists desirability for receiving funding. In such a manner, several members may review each finalist company, with each member having experiences and insight potentially valuable to the finalists. For example, it is likely that attorneys, bankers, executives, and other specialists will evaluate finalists as to their fitness for funding. Such a high level of timely collaboration by specialists provides valuable feedback to each finalist company, and enables a lower risk funding decision to be made.

The collaboration effort enabled by the funding method 10 may be referred to as a collaboration swarm effect. As hinted by the name, a swarm effect efficiently uses a group effort to promptly provide a desired outcome. For example, method 10 provides the mechanism to efficiently collect trusted information regarding a funding candidate, and then facilitates timely evaluation by experts and other specialists. In such a manner, an evaluation and funding decision can be made promptly and with minimized risk as compared to known evaluation methods.

In block 20, each finalist company is encouraged to agree to a valuation, which is likely to have been assigned by one or more of the experts in block 16. Most investors need such valuation agreement prior to funding. However, it will be appreciated that the valuation agreement may be avoided depending upon the specific requirements of the entity providing funding. Finally, in block 22 one or more of the finalists is selected to receive funding as shown in block 31.

Due to the desirability of funding method 10, it is likely that a large number of companies may compete for available funds. Since the companies are able to present their information in a controlled and secured manner, it is likely that more complete and accurate information is collected and presented. Further, review by selected experts provides a valuable analytical basis for funding decisions. Funding method 10 also enables the timely and efficient collaboration from specialists in a wide range of fields to further reduce funding risks.

In a preferred embodiment, the pool of companies attracted to enter information is expected to be over 1000 companies. The systematic filtering 14 is preferably expected to reduce the number of companies to about 200 in the manageable subset. Selected experts preferably first apply a fairly automatic process to reduce the number of companies even further, possibly to about 100, and then perform comprehensive review on the 100 companies before selecting about 20 finalists. Using the event website, each of the finalists in block 29 will be presented to the members in the member database, and evaluations solicited. Each finalist's website presentation will include that company's non-private information, the expert analysis, and a tabulation of previous member evaluation.

In a preferred embodiment of the website presentation and evaluation, the event website presents tabulated results and requests evaluation in an “opinion poll” format. In this regard, when a member reviews a finalist's information, other members' ratings appear as a tabular or graphical presentation. The presentation can include, for example, how others rate the finalist's chance of success, likelihood of the finalist being acquired, or probability of the finalist making it to the IPO stage. In the opinion poll format, the member is requested to rate the finalist in these same categories, and then that member's ratings are aggregated in the next presentation of the ratings. In a particular example of the opinion poll, a member must respond with ratings before the opinion poll results are displayed. It will be appreciated that the website presentation may contain more or less information, and may be alternatively presented.

The finalists are then typically requested to approve their valuation as a condition of further consideration for funding. Companies that disagree with their valuation may be less likely to be funded, and the funded company will typically be selected from the group of finalists approving their valuation. Such funding selection may be made on several bases, including the company's provided information, the expert review, and the member evaluation. It will be appreciated that the funding selection may be made using other criteria. It will also be appreciated that the number of companies in each level may be adjusted consistent with this disclosure.

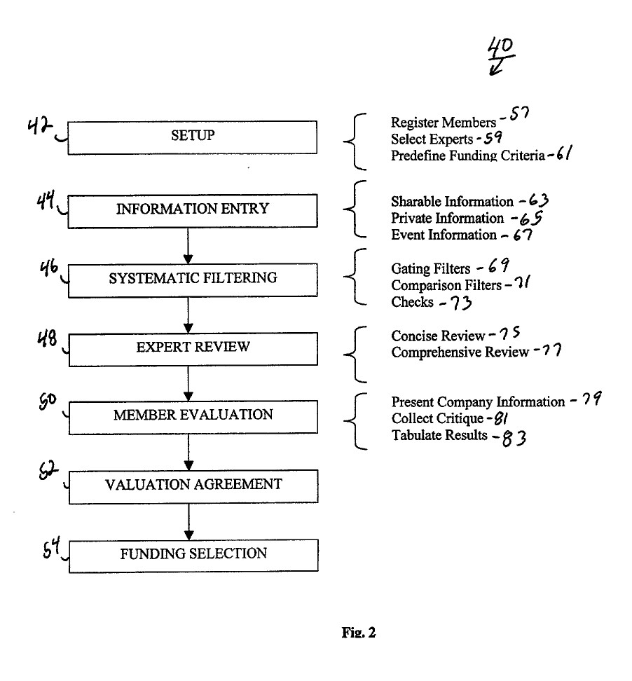

Referring now to FIG. 2, funding method 40 is disclosed in more detail. Funding method 40 is similar to funding method 10 so only additional detail and differences will be described. For example, funding method 40 more fully describes the setup process 42. Setup process 42 may include registering members into a member database as shown in block 57. The registration process may include receiving information for each of the members. Preferably, data items for each member may be assigned a security level. For example, each member may be able to assign a private level to information that is not to be shared directly with other members. In a similar manner, each member may be able to define information which is freely sharable to other members, but which may not be disclosed outside the member database.

As described above, an event manager may desire to operate a funding competition. The event manager may predefine funding criteria 61 for the funding competition. For example, the event manager may define the funding criteria to focus a particular funding competition to a particular technology or to a particular funding phase. In a more specific example, an event manager may define funding criteria to focus a funding event on biotech start-ups seeking their first funding.

Dependant on the focus of the funding event, the event manager will select experts 59 from the members in the member database. The event manager then solicits companies to participate in the funding competition that are likely to meet at least general funding criteria. Companies attracted to the funding competition participate by accessing the event website. Preferably, participating candidate companies are registered in the member database.

Participating candidate companies enter their information in block 44. Each of the companies is already registered as a member so some information, private or sharable, is already available on that company. The event website generally presents a questionnaire to each company where the company can provide additional, sharable information 63 and additional private information 65. Further, the questionnaire may seek to find information specific to the particular event operated by the event manager.

The questionnaire may have yes-no type questions, multiple choice questions, or open-format response questions. It will be appreciated that the questions may take many forms and may request different information specific to the type of funding event being operated. However, the questionnaire will generally ask questions designed to understand the company's financial condition, market penetration, management capability, past funding, technology, customers, existing partners, and business plan.

Block 46 again describes systematic filtering to reduce the number of companies under consideration. Such systematic filtering is automatically performed and may include simple dating filters looking for companies meeting minimum requirements, or more sophisticated comparison filters 71 implementing the funding criteria as defined by the event manager. Optionally, manual or systematic checks 73 may be established to validate the systematic filtering. For example, the gating filter 69 may have eliminated a company for not meeting minimum or desired requirements of the funding event, but the company growth rate, for example, makes it a strong candidate for funding anyway. In such a manner checks 73 may provide an alternate path for the company to further participate in this funding event or to be identified as a potential candidate for another funding event.

Companies surviving the systematic filtering are then reviewed by experts in block 48. Such expert review may include a concise review 75 to eliminate a first round of companies, and a comprehensive review 77 of the remaining companies. The concise review may be implemented using semi-automatic processes useful for evaluating the companies' answers in the questionnaires. For example, experts may use a known spreadsheet or other program to sort, present, and compare answers to questions. Although it may be possible to automate at least some of the concise review, a human process reduces the risk that an attractive candidate is eliminated from the competition. It will also be appreciated that the selected experts may be given access to the event database during the expert review. In this manner, the experts may review company participants, and provide guidance in adjusting event criteria, such as the systematic filtering algorithms as well as manage the ongoing process of their review by marking and tracking select companies.

For those companies passing the concise review, the comprehensive expert review is likely to include personal interviews of senior management at the company, detailed investigation of financial statements, and other typical due diligence steps.

Using comprehensive review, the experts have reduced the field of companies to a few finalists. The finalist companies are presented to the membership of the member database using the event website. Each company's information is presented 79, evaluations are collected 81, and results are tabulated 83. In a preferred embodiment, the results are tabulated in real time so that evaluating members may understand how previous members evaluated a particular company.

In a particular example of member evaluation, each finalist may be required to have their CEO evaluate all the other finalists. The event manager could then gauge how accurately each CEO is able to evaluate business opportunities. For example, if a particular CEO rates one of the finalists as being a poor investment opportunity, while the rest of the experts and CEOs find it to be a good investment, then that CEO may be judged by the event manager to lack good investment judgment. It will be appreciated that having all the finalist CEOs review all the other finalists may identify other areas of strength or weakness for the CEOs.

One or more of the finalist is selected to receive funding in block 54. As before, it is likely that any company selected to be funded has agreed to their valuation as shown in block 52. It will be appreciated that companies not agreeing to their valuation may be allowed to continue in the event to gain exposure to investors, but that without an agreement on valuation it is unlikely that they would be selected to receive funding in the funding event.

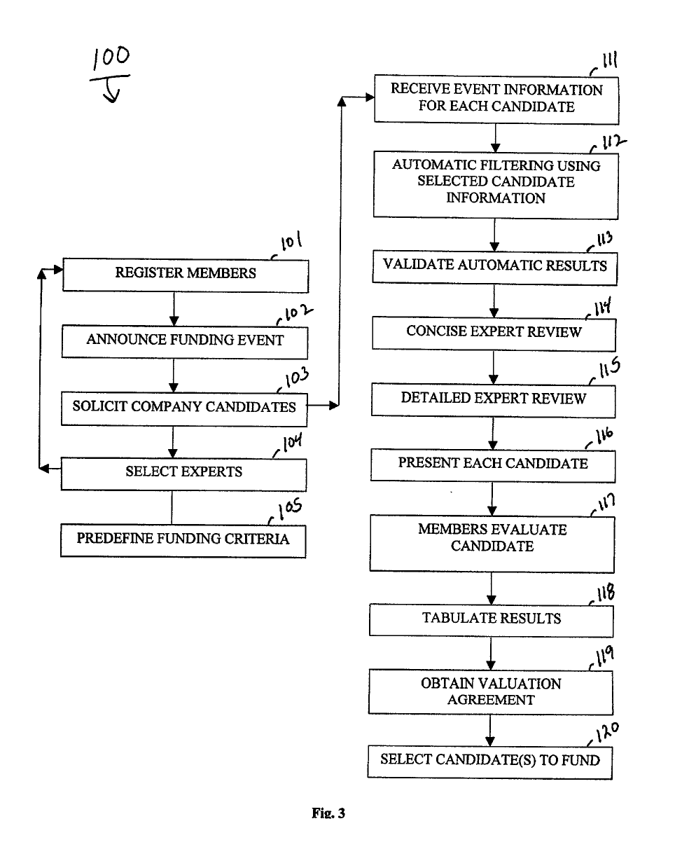

Referring now to FIG. 3 another method of funding 100 is shown. Method 100 has membership registration as shown in block 101. For example, members may register in a membership database by entering private or sharable information. Members may include for example, companies seeking funding, specialists, venture capitalists, angel investors, or other entities related to financial markets.

In block 102 an event manager announces a funding event. For example, the funding event may announce to members and nonmembers that a fund has been established to provide capital to one or more companies winning a competition. It would be appreciated that other types of funding events may be established. For example, a funding event may be established whereby investors are encouraged to provide additional funds into a fund intended to provide capital to companies meeting established minimum criteria. Thus, a funding event may be established for competition among companies seeking funding, or competition between funders to be permitted to put money in the fund. In this latter circumstance, the funders would be competing to provide the most desirable financial terms for their target investments. It will be appreciated that the investors would be motivated to provide more lucrative financial terms based upon the quality and trustworthiness of the financial information provided for the target companies.

The event manager also defines funding criteria, as shown in block 105. The funding criteria includes defining the questionnaire, selecting information to be used in the systematic filtering, and establishing criteria for the experts to use in their concise and comprehensive review. It will be appreciated that the funding criteria may include other guidance in implementing the funding event.

In block 103 company candidates are solicited for the funding event. As described above, alternatively the solicitation could be for funders, such as angels or venture capitalists. The solicitation is likely to be presented not only to all members, but is likely to be presented outside the membership database, such as on other web sites and in publications.

Block 104 shows that experts are selected for the particular funding event. Typically, the experts would be selected by the event manager or be one acting in the event manager's capacity. Experts would be selected based on their historical success, expertise, education, and reputation. The member database may also provide for rating experts. Such a rating could be based on, for example, the historical accuracy of a particular expert's investment predictions, or a proven performance with successful funding transaction. If the member database uses a rating system, the ratings may also be used to select experts for a particular funding event. Further, experts would be selected responsive to the particular funding event under consideration. For example, if a funding event is focused on private software companies, it would be highly desirable to select experts with a proven track record with early stage software companies. The process of registering members, announcing the funding event, soliciting candidates, and selecting experts may extend over a period of time, for example, three months.

Responsive to the solicitation of candidates in block 103, companies are likely to respond and input event information into the system as shown in block 111. As described earlier, if a solicited company is not a member, they first would register as a member and then provide event specific information by typically filling out the event's questionnaire.

Based on the predefined funding criteria 105, an automatic filtering is applied to each candidates information. In a preferred embodiment, such automatic filtering is a gating function that looks at a subset at the answers provided by each candidate to establish that each candidate meets minimum requirements. For example, if the event manager desires only to consider companies with more than 50 employees, then a gating decision may be made to eliminate all companies providing an answer indicating the company has less than 50 employees.

To encourage the widest participation by candidate companies, specific funding criteria 105 would not be publicly shared. Further, the funding criteria may be changed during the course of the funding event dependent on specific information received from candidate companies. For example, if too many companies remain after applying the gating filter of 50+ employees, then the criteria may be raised to, for example, 100 employees, to further restrict the number of companies making it to the next level of consideration.

Such adjustment of the new predefined funding criteria 105 may also be part of the validation of the automatic results done in block 113. Further, the validation 113 may apply automatic or manual algorithms to assure that highly attractive candidate companies have not been unnecessarily eliminated. Companies identified as having been unnecessarily eliminated may be moved to the next level of competition, or may be identified for other funding events.

The companies that survive the automatic filtering process now represent a manageable subset of companies. This manageable subset of companies is exposed to a concise expert review 114. The concise expert review 114 may be for example, a review of all company answers with the assistance of automated processes such as spreadsheets or another program. Preferably, a plurality of experts review the subset of manageable companies. If the subset of manageable companies is too large for all experts to review all companies, the subset may be further subdivided to enable concise evaluations of smaller groups of companies. In such a manner, the strongest companies from each group would be selected to be included in the detailed expert review 115.

The detailed expert review 115 preferable has a plurality of experts doing a detailed analysis of each of the finalist companies. Such a detailed review is likely to include personal interviews of senior management and other such due diligence efforts. The experts may then prepare a written report on their findings regarding each company and may further provide objective ratings to facilitate nonexpert understanding of the risk of investing in that company.

Once the experts have finished their detail review of each of the finalist companies, information regarding each company candidate is presented to the members in the member database. Preferably, when a member enters the computerized event site, which is likely to be the funding Internet website, the member would be invited to review and evaluate one or more of the finalists.

If a member chooses to review and evaluate a finalist, the member would be presented with specific company information. For example, that company's sharable information may be directly presented to the member, along with the reports and ratings provided by the experts. Further, the member may be presented with specific or aggregated evaluations from prior members. In this way, the member would understand how the company sees itself, how experts see the company, and how other members see the candidate company.

After all the finalists candidates have been presented to the members, results are tabulated in block 118. In a preferred example, the event manager either makes funding selections or chooses specific experts to make the funding selection, as shown in block 120. Since having an agreement of the valuation of a company is typically necessary prior to funding, it is likely that a valuation agreement will be obtained in block 119 before an announcement of the selected candidate or candidates is made.

In a particular embodiment of the selection process 120, the selection process is completed at an awards ceremony. In particular, finalists having signed the valuation agreement are invited to an event where each company first makes a private “pitch” to a select group of attendees, such as the experts used in the event, and later make a presentation to all attendees. Since the first presentation is to a group that has already had access to the finalists' private information, each finalist can freely discuss private company details, while the second presentation is likely to be more general in nature.

It is envisioned that ceremony attendees will include funders in the form of angels, venture capitalists, and investment bankers, along with experts and specialists in the event field. Due to the extensive process and quality of trusted information leading to the awards ceremony, all finalists are likely to be reasonable investment candidates. Accordingly, even those that do not receive funding through the event are potential candidates for funding from other sources. In this way the award ceremony provides an opportunity for the finalists to receive highly advantageous publicity, while funders are presented with investment opportunities in a manner which minimizes investment risk.

At the awards ceremony, one or more of the finalists is selected for funding. The selection is preferably based on each finalist's private and sharable information, expert analysis, member evaluation, and final presentations.

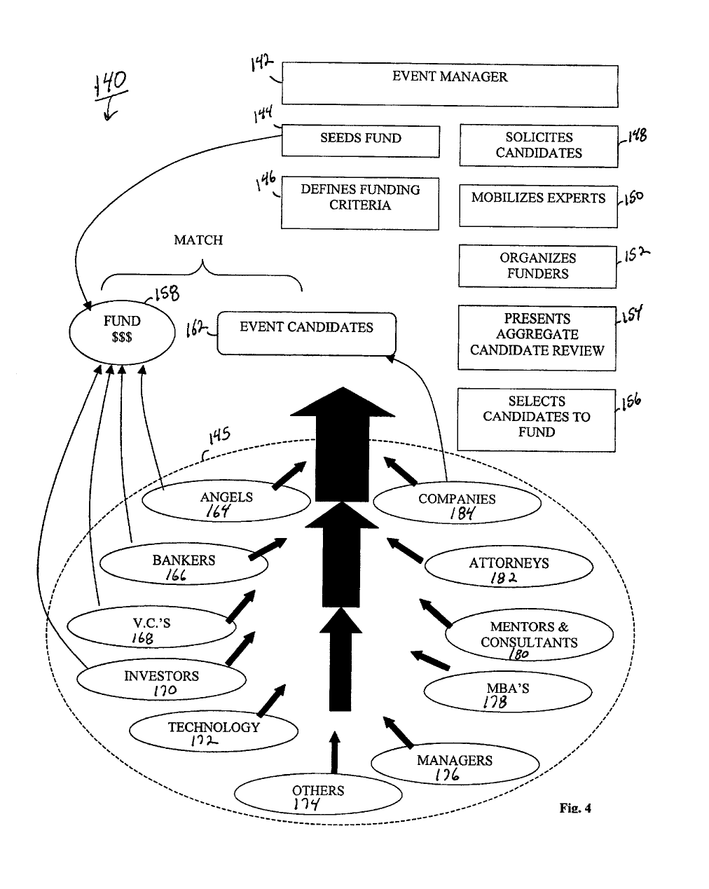

Referring now to FIG. 4 another method 140 of funding is shown. Method 140 has an event manager 142 that establishes a funding event such as a funding competition. The event manager 142 also defines funding criteria, on behalf of the capital source's objectives, that will be useful in the process for selecting which company or companies receive funding. The event manager also seeds the investment fund 158 as shown in block 144. In this manner the event manager may provide a substantial or entire amount of the fund, or may simply seed the fund with a minor amount of the intended fund level.

As described earlier, the event manager also solicits candidates 148, mobilizes experts 150, presents candidate information for review 154, and participates in selecting the candidates to fund 156. In method 140, the event manager may also organize funders to contribute to the fund 158. In such a manner, the event manager acts as a fund manager, attracting and evaluating high quality companies and thereby attracting funders having desirable financial terms.

As with previously described methods, method 140 has a database of members 145. Member database 145 may have individual registered members such as angels 164, bankers 166, venture capitalists 168, investors 170, companies seeking funding 184, attorneys 182, mentors and consultants 180, MBAs 178, managers 176, technology partners 172, and others interested in the financial markets 174. Accordingly, the member database 145 contains potential collaborators having an incredible wealth of experience and expertise. Advantageously, method 140 is structured to facilitate timely and effective collaboration. In effect, the method 140 enables the power of the available resources and “swarm” expertise to companies participating in the event by promptly evaluating and interacting to reach an evaluation for each company. Both investors and participating companies benefit from this swarm effect.

In method 140 some of the companies 184 may participate in the funding event and therefore become event candidates 162. As companies proceed through the funding event as previously described, members are encouraged to evaluate and collaborate regarding specific candidates. In such a manner, each candidate is the beneficial receiver of information from a wide variety of specialists, experts, and investors.

Due to the highly collaborative nature of method 140, risk maybe reduced in making funding decisions. As risk of funding decisions is reduced, and funders find that event candidates present desirable funding candidates, then the funders will be attracted to contribute additional funds into fund 158. For example, angels 164, bankers 166, venture capitalists 168, and other investors 170 could vie for the opportunity to participate in fund 158. As the fund 158 grows and the terms of the funding become more lucrative, more event candidates would be drawn into the event. Thereby, method 140 provides a dynamic structure for collaboration in a trusted environment that facilitates the lowest risk investment opportunities receiving the most funding at attractive financial terms.

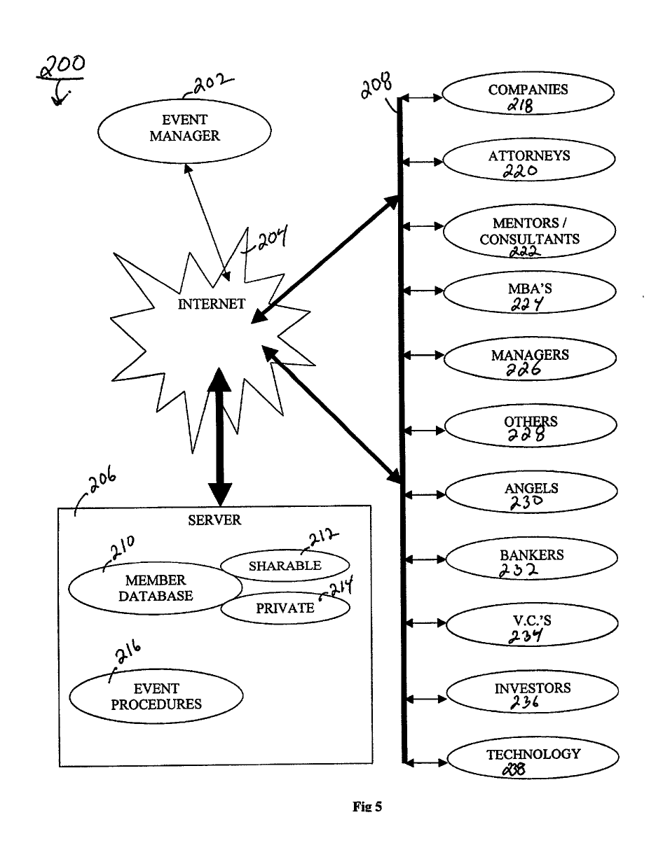

Referring now to FIG. 5 a system for funding a company is shown. The system 200 preferably uses the Internet 204 as a network configuration. It would be appreciated that other networks could be used. For example, a private intranet,bulletin board, or interactive television system may be substituted.

An event manager 202 communicates through the Internet via a client. The Internet also communicates to a server 206 that contains a member database 210. As described earlier, the member database may include information from a wide variety of members such as companies 218, attorneys 220, mentors/consultants 222, MBAs 224, managers 226, and other 228. Further, funders may be represented such as angels 230, bankers 232, venture capitalists 234, and other investors 236. Also technology partners or available technology may be shared in the database 238.

Each of the members in the database may have their information with a security level such as sharable 212 or private 214. In this way some information may be freely viewable by other members, such as the sharable information 212. Other information, such as private information 214, would be used by the server applications or on another limited basis.

As described above, the event manager 202 may define event procedures for a funding event, such as a funding competition. The event procedures 216 are preferably stored on the server and would include such items as event solicitation plans and systematic filtering procedures. Further, the event procedures 216 may enable the presentation of finalist companies to the members and provide a means for receiving evaluations or ratings from the members regarding the finalists.

Each of the members could connect to the Internet 204 in a variety of ways. For example the connection 208 could be a wireless connection or a hardwired client system, such as a personal computer. In a preferred embodiment, each of the members communicates through the Internet 204 to the server 206 using commercially available security system, such as an encryption technology.

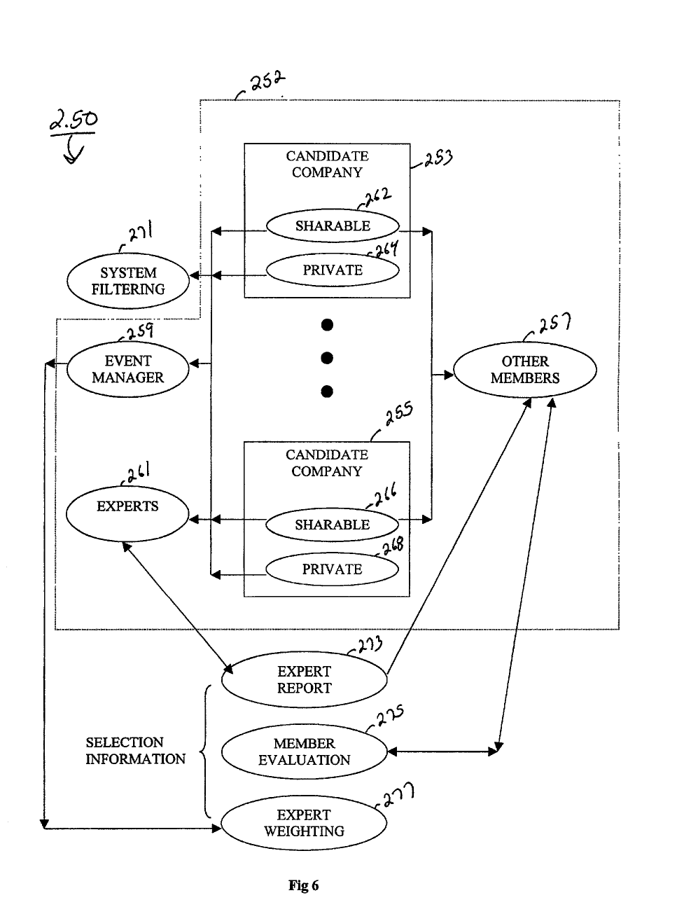

Referring now to FIG. 6 data flow for method of funding is described. Each of the candidate companies such as candidate company 253 and 255 have existing information from their membership registration included in sharable information 262, 266 or private information 264, 268. Additionally, when each candidate company enters a funding event, typically by answering a detailed questionnaire, certain of the responses may be identified as sharable information or private information. Sharable information is information that may be shared with other members as entered, while private information may be used only on limited terms by the funding event or the member database system.

More particularly, the event manager 259 and any selected experts 261 are likely to have access to all sharable and private information from company candidates. In a similar manner the systematic filtering 271 performed automatically by the system also is likely to have access to all sharable and private information. Accordingly decisions by the systematic filtering, the event manager, and the experts are based on information not directly sharable by all members or outside the membership database. In this regard, company candidates are more likely to give complete and accurate information in such a secure and confidential environment.

In contrast, other members 257 only have direct access to sharable information. Only indirectly through expert reports 273 do the other members 257 obtain an insight into any private information. Since the expert reports 273 are likely to be in summary or rating form, the risk of releasing private information is minimized. Other members 257, which will be invited to evaluate all finalists companies, also preferably have access to other member evaluations 275. Such access may be provided either by directly viewing individual member evaluations, or by being presented a tabulation of previous evaluation summaries. In such a manner each evaluating member will have the benefit of each company's sharable information, expert reports, and other members evaluation prior to performing their own review and evaluation.

In a particular preferred embodiment, ratings are applied to particular experts. In this way an expert with a solid history of accurate analysis would be giving more weight than a new expert or expert who had had less success. In a similar way, the information flow 250 could be modified to also weight other members' evaluations. In this way a member with a history of solid analysis would be given greater weight than the evaluation of a new member or a member with a less successful history. The event manager or someone selected by the event manager could then use the expert reports 273, member evaluations 275, weighting factors 277, and all sharable and private information from each company in selecting the company to be funded. It will be appreciated that other factors may be considered in making a selection. For example, finalists may make an in-person presentation to those making the selection.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A method of funding a company using a web-based funding event, comprising:
receiving entry information from each company in a pool of companies;
filtering systematically the entry information to select a manageable subset of companies, the filtering applying predefined filtering criteria;
reviewing by experts to select finalist companies from the manageable subset of companies;
presenting finalist companies to members identified in a member database;
collecting evaluations from the members regarding the finalist companies; and
selecting, responsive to the collected evaluations, at least one company to be the funded company.

2. The method according to claim 1, further comprising the setup step of registering the members, the experts, and each company in the pool of companies into the member database.

3. The method according to claim 1, further comprising the setup step of defining the automatic filtering criteria.

4. The method according to claim 1 wherein the entry information is received in the form of answers to a set of candidate questions.

5. The method according to claim 4 wherein the filtering criteria is applied to a subset of the set of questions.

6. The method according to claim 1 further including the step of using at least some of the experts to comprehensively review the finalist companies before presenting the finalist companies to the members.

7. The method according to claim 1 wherein the collecting step further includes collecting evaluations from at least some of the experts.

8. The method according to claim 1 wherein the collecting step further includes collecting evaluations from at least some of the finalist companies.

9. The method according to claim 1 further including the step of obtaining valuation agreement with at least some of the finalist companies, and selecting the funded company from the agreeing companies.

10. A method for funding a company, comprising:
registering members into a member database, the members including funders, companies, and experts;
defining funding criteria for a funding competition;
seeding a fund, the fund for holding money to fund the company;
selecting some of the members to be experts in the funding competition;
soliciting some of the companies in the member database to enter the funding competition, the responding companies forming a pool of companies;
filtering systematically the pool of companies to select a manageable subset of companies;
reviewing by the experts the subset of companies to select finalist companies;
presenting the finalist companies to the members;
collecting evaluations from at least some of the members regarding the finalist companies;
presenting evaluation results for the finalist companies; and
selecting at least one company from the finalist companies to be the funded company.

11. The method according to claim 10, further including the step of enabling funders in the member database to contribute additional funds into the fund.

12. A method of funding a company using an event website, the event website implementing a funding competition, comprising:
registering companies, funders, and experts into a member database, each company providing private information and sharable information;
receiving on-line entry information from a plurality of candidate companies desiring to compete in the funding competition, the candidate companies being a subset of the registered companies;
filtering systematically the entry information to select a manageable subset of companies, the filtering applying predefined filtering criteria to private information and sharable information;
reviewing the private, the sharable, and the event information from each company in the manageable subset of companies by event experts to select finalist companies, the event experts being selected from the registered experts;
presenting finalist companies on the website to visiting members registered in the member database;
collecting evaluations from the visiting members regarding the finalist companies; and
selecting, responsive to the collected evaluations, at least one company to be the funded company.

13. The method according to claim 12, further including the step of presenting each finalist company individually on the event website for 1 day.

14. The method according to claim 12, further including the step of having each finalist make an event presentation at an awards ceremony, and using the event presentation as one of the criteria in selecting the company to be funded.
